(19) United States
(12) Patent Application Publication
(10) Pub. No.: US 2010/0258523 A1
(43) Pub. Date: Oct. 14, 2010

(54) METHOD FOR MANUFACTURING STAMPER

(75) Inventors: Yasuaki Ootera, Yokohama-shi (JP); Masatoshi SAKURAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/756,083

(22) Filed: Apr. 7, 2010

(30) Foreign Application Priority Data
Apr. 8, 2009 (JP) 2009-094186

(51) Int. Cl. G11B 3/72; B44C 1/22

(52) U.S. Cl. 216/11

(57) ABSTRACT

According to one embodiment, an injection-molded recess and protrusion pattern surface of a resin stamper is subjected to a dry etching process for surface treatment.

### CROSS-REFERENCE TO RELATED APPLICATIONS

This application is based upon and claims the benefit of priority from Japanese Patent Application No. 2009-094186, filed Apr. 8, 2009, the entire contents of which are incorporated herein by reference.

### BACKGROUND

1. Field

One embodiment of the present invention relates to a method for manufacturing a stamper used to manufacture a magnetic recording medium having discrete tracks on the surface of a magnetic recording layer.

2. Description of the Related Art

Discrete track media (DTR) are now examined as means for increasing the density of magnetic disks. Grooves are formed in the surface of a discrete track (DTR) medium to separate tracks from one another in order to increase the recording density in a track direction. Furthermore, simultaneously with the formation of the grooves between the tracks, a servo pattern can be engraved in the form of recesses and protrusions. Thus, improved patterning eliminates the need to record servo signals on each medium, allowing productivity to be improved.

In a process of manufacturing a DTR medium, as disclosed in, for example, Jpn. Pat. Appln. KOKAI Publication No. 2003-157520, an imprint stamper is pressed against a resist coated on the surface of a magnetic recording layer to transfer a recess and protrusion pattern to the resist. Moreover, the magnetic recording layer is processed through the resist as a mask.

As such an imprint stamper, an Ni stamper is produced and duplicated by an electroforming process and used as a father stamper, a mother stamper, or a sun stamper. However, the electroforming process disadvantageously requires a long production time of about one hour per Ni stamper. In contrast, the first Ni stamper may be produced as a father stamper by the electroforming process, and a mother stamper or a son stamper may thereafter be produced using an injection molding process. Then, a resin imprint stamper is obtained in a short production time of several seconds per stamper.

The injection molding process has been used to produce optical disks.

For the discrete track magnetic recording medium, making the track grooves thinner and smoother is important. For example, a currently examined density corresponds to a track pitch of several tens of nm. However, to ensure the SN ratio of signals, land portions in which signals are recorded, that is, protruding portions or magnetically active portions, need to be wide, in other words, the track grooves, that is, the recess portions or magnetically inactive portions are desirably as narrow as possible. Furthermore, as the track pitch decreases in the future in connection with improvement of the recording density, the track groove will be further narrower. Additionally, the edge roughness of the track groove may serve as a source of noise and thus of course affect the quality of recording and reproduction signals.

The need to reduce the width of the groove will be described below in comparison with that for an optical disk. The optical disk involves land groove recording and groove recording. In the land groove recording, a mark needs to be recorded both in the land (island) portion and in the groove portion. Thus, the ratio of the land to the groove is desirably about 1:1. On the other hand, in the groove recording, recording is actually performed sometimes only on the groove portions and sometimes only on the land portions. However, in either case, when a recording target site (groove or land) is excessively narrow, the area (or volume) is small in which a recording mark is formed in response to a recording signal. This prevents the signal from being successfully written, thus degrading the SN ratio. Furthermore, the optical disk offers a large recording and reproducing light spot with respect to the recording track pitch. Thus, when a non-recording-target site (land or groove) is excessively narrow, a recording mark for the adjacent track may be misrecognized (or misrecorded). Consequently, in the optical disk, both the grooves and the lands need to avoid being excessively narrow. On the other hand, excessively wide grooves or lands may reduce the recording density. Thus, the optimum value is present. For example, in a Blu-ray disk, the land and groove pitch is about 0.32 μm, and the ratio of the width of the land to the width of the groove is about 1:1. This pitch is about fivefold larger than that in the discrete magnetic disk. On the other hand, in the magnetic disk, particularly the DTR medium, signals are recorded in the land portions as referred to herein. However, when each land is narrow, then as in the case of the optical disk, the area is small in which a recording mark is formed in response to a recording signal. This prevents the signal from being successfully written, thus degrading the SN ratio. However, in the magnetic disk, the effective area of the recording and reproducing head is small with respect to the recording track pitch. Thus, the possible misrecognition of the recording mark in the adjacent track is negligible. If each track is physically and magnetically separated from the adjacent tracks via grooves, misrecording is also negligible. Thus, when an attempt is made to increase the recording density, a reduction in the width of the land is limited. However, narrower grooves are more advantageous for the density provided that each track is separated from the adjacent tracks via the grooves.

Thus, the injection molding process, conventionally used to produce optical disks, is considered to be useful for molding of the stamper used to form a recess and protrusion pattern on the surface of the discrete medium. However, the ratio of the land width to the groove width required for the recess and protrusion pattern is different from that in the optical disk. Consequently, high-quality stampers cannot be obtained by directly using the technique used for the optical disk. Therefore, further improvement of the technique has been desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram showing an example of the configuration of a resin stamper molding die according to the present invention;

FIG. 2 is a diagram showing the blocks of forming a discrete track magnetic recording medium;

FIG. 3 is a diagram showing the blocks of manufacturing a metal stamper;

FIG. 4 is a diagram showing an example of a magnetic recording and reproducing apparatus using the discrete track magnetic recording medium according to the present invention;

FIG. 5 is a diagram showing an example of how a recess and protrusion pattern surface of a resin stamper according to the present invention appears before and after surface treatment carried out on the resin stamper;

FIG. 6 is a diagram showing an example of how the recess and protrusion pattern surface of the resin stamper according to the present invention appears before and after surface treatment carried out on the resin stamper;

FIG. 7 is a diagram showing an example of how the recess and protrusion pattern surface of the resin stamper according to the present invention appears before and after surface treatment carried out on the resin stamper; and

FIG. 8 is a diagram showing an example of how the recess and protrusion pattern surface of the resin stamper according to the present invention appears before and after surface treatment carried out on the resin stamper.

### DETAILED DESCRIPTION

Various embodiments according to the invention will be described hereinafter with reference to the accompanying drawings. In general, according to one embodiment of the invention, a method for manufacturing a resin stamper is provided, that has a recess and protrusion surface applied to transfer a recess and protrusion pattern to an ultraviolet setting resin used as a mask for forming discrete tracks composed of the recess and protrusion pattern, on a surface of a magnetic recording layer, wherein the recess and protrusion pattern surface of the resin stamper is subjected to a dry etching process for surface treatment.

In an aspect of the method for manufacturing the resin stamper according to the present invention, when the recess and protrusion pattern surface of the resin stamper is subjected to the dry etching process, each protruding portion is thinned to widen each recess portion. Thus, the resin stamper with the wide recess portions can be formed.

Furthermore, in another aspect of the method for manufacturing the resin stamper according to the present invention, when the recess and protrusion pattern surface of the resin stamper is subjected to the dry etching process, each protruding portion is thinned to widen each recess portion. The protruding portion thus has a triangular vertical cross section.

In another aspect of the method for manufacturing the resin stamper according to the present invention, when the recess and protrusion pattern surface of the resin stamper is subjected to the dry etching process, the roughness of the recess and protrusion pattern surface of the resin stamper can be reduced to smooth the recess and protrusion pattern surface, with the recesses and protrusions of the recess and protrusion surface maintained.

By reducing the roughness of the recess and protrusion pattern surface of the resin stamper to smooth the recess and protrusion pattern surface, the recess and protrusion pattern surface of the discrete magnetic recording medium can be prevented from being roughened. Thus, the resulting magnetic recording medium suffers reduced noise.

Furthermore, if a mother stamper or a father stamper is used to repeatedly transfer the recess and protrusion pattern, the costs of an exposure apparatus based on electron beams can be reduced when the width of the recess portion is equivalent to that of the protruding portion instead of being significantly different from that of the protruding portion. A higher acceleration voltage is required to form thin grooves. This increases the costs of the apparatus. Furthermore, a decrease in the thickness of electron beams used for exposure reduces the amount of current, and makes the value of the required master recording time unpractical for mass production 6. Additionally, smoothing the track grooves to reduce roughness is difficult.

In contrast, the method according to the present invention is used to transfer the recess and protrusion pattern with the groove width equivalent to the land width to the resin stamper. Then, a dry etching process is used to reduce the roughness of the recess and protrusion pattern surface to smooth the recess and protrusion pattern surface or to process the recess and protrusion pattern surface so that the protruding portion width is smaller than the recess portion width. Then, the resin stamper having the recess and protrusion pattern used to form the discrete tracks can be formed accurately, easily, and inexpensively. The vertical cross section of the protruding portion may be rectangular or triangular.

The present invention provides a method for manufacturing a magnetic recording medium, the method forming a recess and protrusion pattern on the surface of a magnetic recording medium using the resin stamper, the method including:

sticking, for example, under vacuum, the surface of the magnetic recording layer in the magnetic recording medium to the treated recess and protrusion pattern surface of the resin stamper via an uncured ultraviolet setting resin layer;

irradiating the uncured ultraviolet setting resin layer with an ultraviolet ray to cure the ultraviolet setting resin layer;

stripping the resin stamper to form, on one surface of the magnetic recording medium, the ultraviolet setting resin layer to which the recess and protrusion pattern has been transferred; and

performing dry etching through the ultraviolet setting resin layer as a mask to form a recess and protrusion pattern on the surface of the magnetic recording layer.

An aspect of the present invention provides a method for manufacturing a magnetic recording medium, the method including:

injection-molding a resin stamper having a recess and protrusion pattern surface corresponding to a recess and protrusion pattern provided in the form of discrete tracks in the surface of a magnetic recording layer;

subjecting the recess and protrusion pattern surface of the resin stamper to a dry etching process to thin each protruding portion to widen each recess portion, thus forming the resin stamper with the wide recess portions;

sticking, for example, under vacuum, the surface of the magnetic recording layer in the magnetic recording medium to the recess and protrusion pattern surface of the resin stamper with the wide recess portions via an uncured ultraviolet setting resin layer;

irradiating the uncured ultraviolet setting resin layer with an ultraviolet ray to cure the ultraviolet setting resin layer;

stripping the resin stamper to form, on one surface of the magnetic recording medium, the ultraviolet setting resin layer to which a recess and protrusion pattern with wide protruding portions has been transferred; and

performing dry etching through the ultraviolet setting resin layer as a mask to form the recess and protrusion pattern with the wide protruding portions on the surface of the magnetic recording layer.

In another aspect of the method for manufacturing the magnetic recording medium according to the present invention, in subjecting the recess and protrusion pattern surface of the resin stamper to the dry etching process to thin each protruding portion to widen each recess portion, thus forming the resin stamper with the wide recess portions, the protruding portion can be thinned so as to have a triangular vertical cross section, thus widening the recess portion. The resin stamper with the wide recess portions can be used to form a recess and protrusion pattern with wide protruding portions as in the case of the above-described aspect of the method for manufacturing the magnetic recording medium according to the present invention.

The method according to the present invention is used to transfer the recess and protrusion pattern with the groove width equivalent to the land width to the resin stamper. Then, the dry etching process is used to process the recess and protrusion pattern so that the width of the protruding portion is smaller than that of the recess portion. Then, a magnetic recording medium in which the width of the recess portion is smaller than that of the protruding portion can be formed accurately and easily.

In another aspect of the method for manufacturing the magnetic recording medium according to the present invention, when the recess and protrusion pattern surface of the resin stamper is subjected to the dry etching process, the resin stamper can be produced in which the roughness of the recess and protrusion pattern surface is reduced to smooth the recess and protrusion pattern surface, with the recesses and protrusions of the recess and protrusion pattern surface of the resin stamper maintained. The stamper can then be used to form a recess and protrusion pattern on the surface of the magnetic recording layer.

By reducing the roughness of the recess and protrusion pattern surface of the resin stamper to smooth the recess and protrusion pattern surface, the recess and protrusion pattern surface of the discrete magnetic recording medium can be prevented from being roughened. Thus, the resulting magnetic recording medium suffers reduced noise.

Furthermore, in the method for manufacturing the resin stamper and the method for manufacturing the magnetic recording medium according to the present invention, Ar gas or a mixed gas of CF₄ and O₂ can be used to subject the recess and protrusion pattern surface of the resin stamper to the dry etching process.

When Ar gas is used to subject the recess and protrusion pattern surface of the resin stamper to the dry etching process, the roughness of the recess and protrusion pattern surface of the resin stamper can be reduced to smooth the recess and protrusion pattern surface, with the recesses and protrusions of the recess and protrusion pattern surface maintained. Alternatively, by further thinning each protruding portion to widen each recess portion, a resin stamper can be formed which includes protruding portions with a rectangular vertical cross section and wide recess portions.

Furthermore, when a mixed gas of CF₄ and O₂ is used to subject the recess and protrusion pattern surface of the resin stamper to the dry etching process, each protruding portion can be thinned to widen each recess portion so that the protruding portion has a triangular vertical cross section.

The present invention will be described below in detail with reference to the drawings.

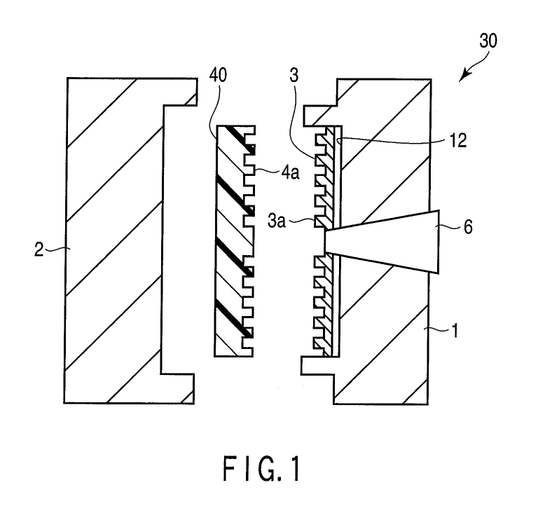

FIG. 1 is a schematic diagram showing an example of the configuration of a resin stamper molding die according to the present invention.

As shown in FIG. 1, a resin stamper molding die 30 has a fixed side template 1 including a metal stamper mounting surface 12 mirror-polished in a random direction, a metal stamper 3, and moving side template 2 located opposite the fixed template 1 across the metal stamper 3. The metal stamper 3 has a recess and protrusion pattern surface 3a with a recess and protrusion pattern which corresponds to, for example, spiral or concentric discrete tracks and a servo shape and which includes recesses and protrusions all having an equivalent width. Reference numeral 40 denotes a schematic illustration of a disk-like stamper that can be injection-molded using the die 30.

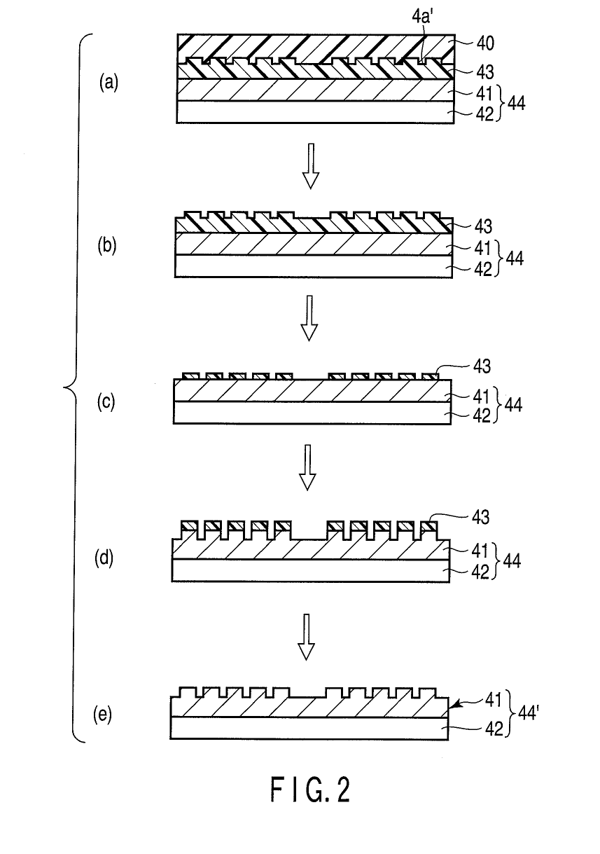

FIG. 2 is a sectional view showing blocks of forming a magnetic recording medium with discrete tracks using a resin stamper obtained from the die shown in FIG. 1.

To form a magnetic recording medium using a resin stamper, a resin stamper 40 is obtained by injection molding using the die in FIG. 1. First, the metal stamper 3 composed of, for example, Ni and having a recess and protrusion pattern 3a corresponding to discrete tracks and a servo pattern is placed on the fixed side template 1 so that the recess and protrusion pattern 3a faces the moving side template 2. The fixed side template 1 and the moving side template 2 are fitted to each other. A molten injection-molding resin is injected into the cavity between the fixed side template 1 and the moving side template 2 through an injection hole 6 leading to a central portion of the fixed side template 1. Subsequently, the templates are pressurized by clamping and then cooled for injection molding. The central portion of the molded article is punched with a cut punch (not shown in the drawings) to obtain a disk-like resin stamper 40 having a center hole. Recesses and protrusions are engraved in the surface 3a of the metal stamper 3. Thus, a recess and protrusion pattern 4a is transferred to the resin stamper 40 molded using the metal stamper 3 as a die. For example, a cycloolefin polymer, polycarbonate, or acrylic can be used as an injection molding resin material.

Then, the resin stamper 40 obtained is subjected to a dry etching process to form a surface-treated recess and protrusion pattern 4a′. This enables a reduction in the roughness of the recess and protrusion pattern surface, with the recesses and protrusions of the recess and protrusion pattern surface maintained. Alternatively, the protruding portions can further be thinned to widen the recess portions, thus forming a resin stamper with the wide recess portions.

Then, as shown in FIG. 2(a), an ultraviolet setting resin 43 is coated on the surface of a magnetic recording medium 44 having a substrate 42 and a magnetic recording layer 41 formed on the substrate 42. The surface-treated resin stamper 40 is then pressed against the ultraviolet setting resin 43, which is then irradiated with ultraviolet rays so as to be cured (UV imprinting).

Subsequently, as shown in FIG. 2(b), the resin stamper 40 is stripped from the ultraviolet setting resin. The resin stamper is stripped to expose the ultraviolet setting resin layer to which the recess and protrusion pattern has been transferred.

Thereafter, as shown in FIG. 2(c), residues of the ultraviolet setting resin 43 in the pattern recess portions are removed by dry etching with, for example, CF₄ gas or O₂ gas. The ultraviolet setting resin 43 is thus bottomed out until the surface of the magnetic recording medium 41 is exposed in the recess portions of the recess and protrusion pattern.

Moreover, as shown in FIG. 2(d), the surface of the magnetic recording layer 41 is processed by ion milling with, for example, Ar, through the ultraviolet setting resin 43 as a mask. Thus, the tracks and the recesses and protrusions of the servo pattern are formed in the surface of the magnetic recording layer 41. The surface of the magnetic recording medium 41 is processed by ion milling.

Thereafter, as shown in FIG. 2(e), the ultraviolet setting resin 43 is removed by dry etching to obtain a discrete track magnetic recording medium 44′.

The following postprocess can be carried out on the resulting magnetic recording medium as required: burial of a nonmagnetic substance in the pattern recess portions, coating of a lubricant, or tape polishing.

The magnetic recording medium used in this case has a size of 1.8 inches, and is 48 mm±0.2 mm in diameter, 12.01 mm±0.01 mm in the diameter of the center hole, and 0.508 mm±0.05 mm in thickness. However, alternatively, a 2.5-inch medium (65 mm±0.2 mm in diameter, 20.01 mm±0.01 mm in the diameter of the center hole, and 0.635 mm±0.05 mm in thickness) may be used.

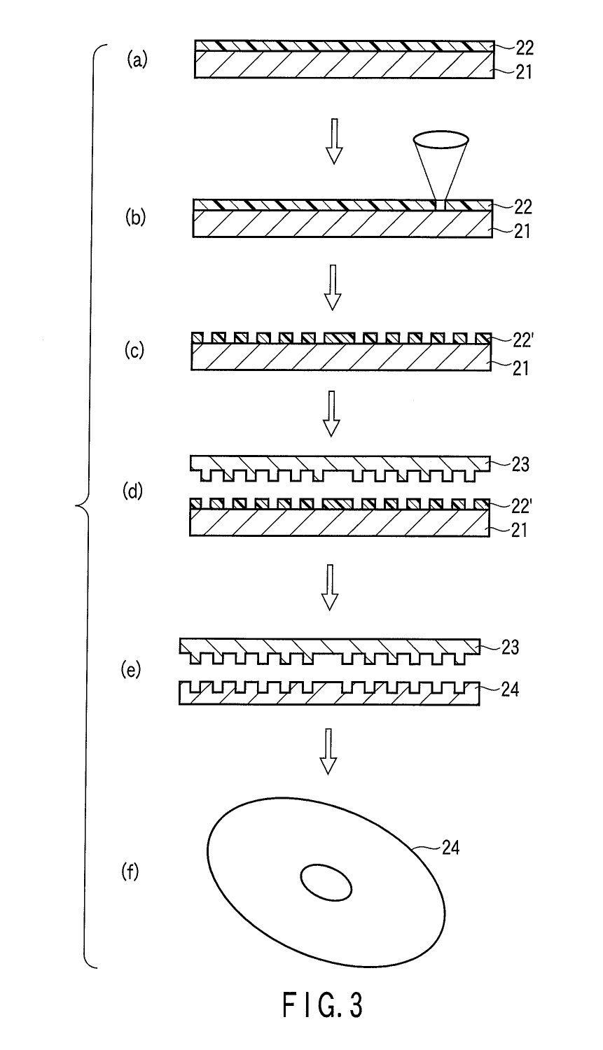

A method for manufacturing a metal stamper will be described with reference to FIG. 3.

As shown in FIG. 3(a), first, an electron beam resist is coated on an Si wafer.

Then, as shown in 3(b), the electron beam resist is exposed to electron beams so as not only to form tracks and a servo pattern.

Subsequently, as shown in FIG. 3(c), the electron beam resist is developed to melt exposed or unexposed portions. Thus, recesses and protrusions 22′ corresponding to the tracks and the servo pattern are formed.

Moreover, as shown in FIG. 3(d), the recesses and protrusions 22′ on the electron beam resist are made electrically conductive and then plated with Ni. Ni is then used to duplicate a pattern to produce an Ni father stamper 23.

Thereafter, the Ni father stamper 23 is plated with Ni to produce an Ni mother stamper 24.

A son stamper and a daughter stamper can be produced as required.

Moreover, as shown in FIG. 3(f), the back surface of the Ni mother stamper 24 is polished to process the center hole and the outer periphery. The Ni mother stamper 24 is thus shaped into donut form so as to be mounted in an injection molding die.

In the present invention, the resin stamper used for the discrete track magnetic recording medium is subjected to the dry etching process to thin and smooth the track grooves (which correspond to the protruding portions on the resin stamper) or to thin the track grooves.

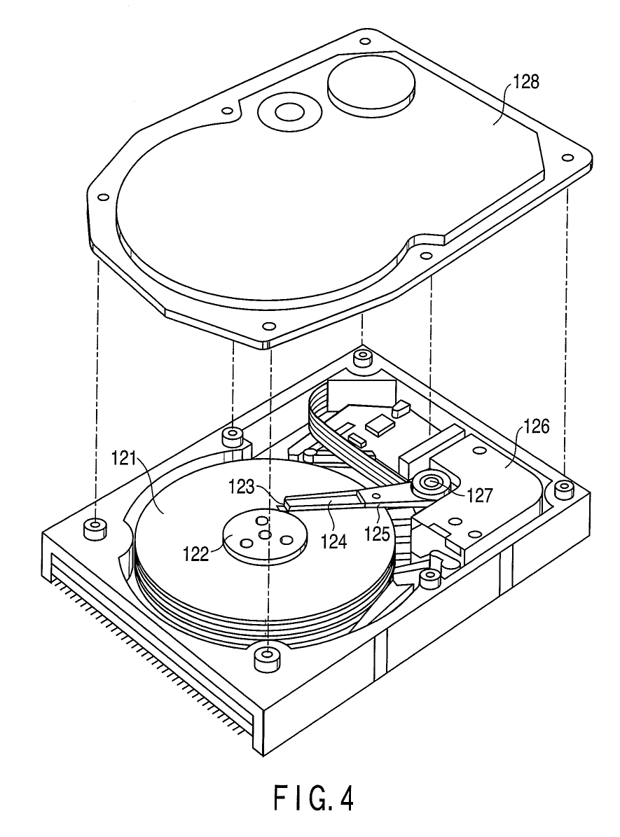

FIG. 4 is a diagram showing the configuration of an example of a magnetic recording and reproducing apparatus using the discrete magnetic recording medium according to the present invention.

A magnetic disk 121 of a rigid configuration on which information is recorded according to the present invention is installed on a spindle 122. The magnetic disk 121 is rotationally driven at a constant rotation number by a spindle motor (not shown in the drawings). A slider 123 is attached to the tip of a suspension 124 composed of a thin plate-like leaf spring; the slider 123 includes, for example, a magnetic-monopole print head accessing the magnetic disk 121 to record information on the magnetic disk 121 and an MR head configured to reproduce information. The suspension 124 is connected to one end of an arm 125 having a bobbin portion or the like which holds a driving coil.

A voice coil motor 126, a kind of linear motor, is provided at the other end of the arm 125. The voice coil motor 126 includes the driving coil (not shown in the drawings) wound up around the bobbin portion of the arm 125, and a magnetic circuit composed of a permanent magnet and a counter yoke arranged opposite each other so as to sandwich the driving coil between the magnet and the yoke.

The arm 125 is held by two ball bearings (not shown in the drawings) provided at an upper position and a lower position, respectively, on a fixed shaft 127 and is rotationally swingably driven by the voice coil motor 126. That is, the position of the slider 123 on the magnetic disk 121 is controlled by the voice coil motor 126. In FIG. 4, reference numeral 128 denotes a cover.

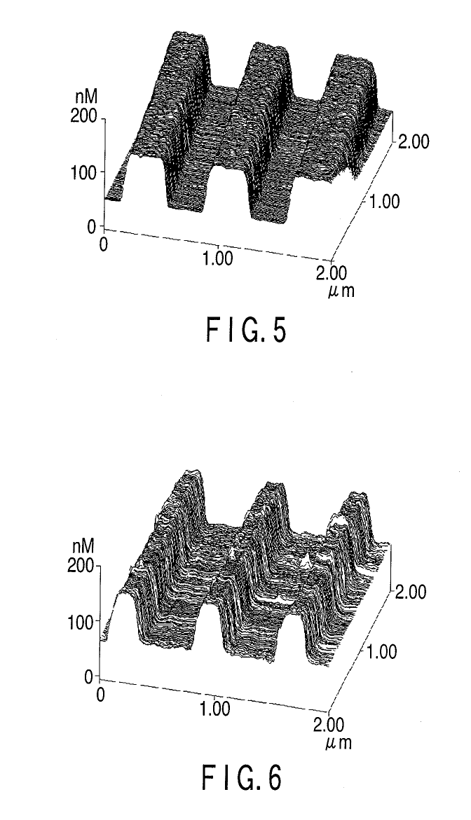

FIG. 5 to FIG. 8 are diagrams showing how the recess and protrusion pattern surface of the resin stamper according to the present invention appeared before and after surface treatment.

All the images in FIG. 5 to FIG. 8 were obtained using an AFM (Atomic Force Microscope). In this example, polycarbonate was used as a resin stamper material. The track pitch was set to 770 nm, and the ratio of the width of each land to the width of each groove was set to 1:1. Alternatively, a cycloolefin polymer or acrylic may be used as the material, and the track pitch may be reduced. Surface treatment was performed using an RIE (Reactive Ion Etching) apparatus.

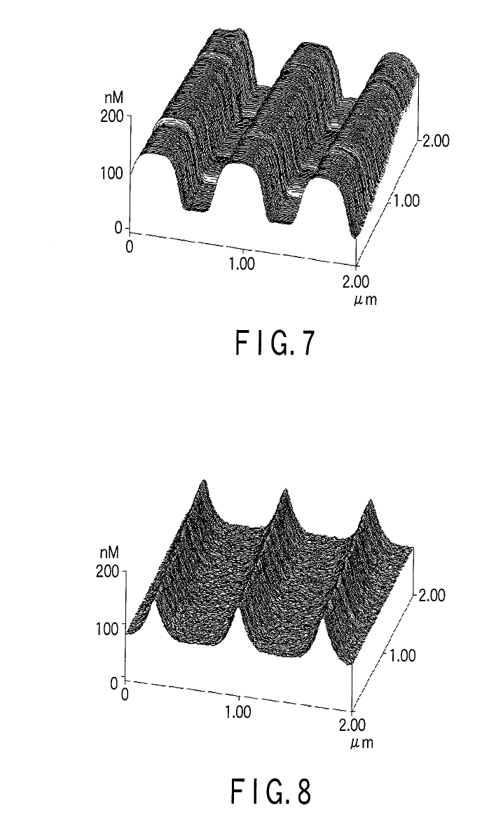

FIG. 5 shows the initial shape of the recess and protrusion pattern surface. FIG. 6 shows the shape of the recess and protrusion pattern surface observed after treatment performed using Ar gas with a flow rate of 50 sccm at a pressure of 1.0 Pa, a power of 140 W, a bias of 0 kV, and a duration of 5 minutes. FIG. 7 shows the shape of the recess and protrusion pattern surface observed after treatment performed using Ar gas with a flow rate of 50 sccm at a pressure of 1.0 Pa, a power of 200 W, a bias of 0 kV, and a duration of 30 seconds. FIG. 8 shows the shape of the recess and protrusion pattern surface observed after treatment performed using a mixed gas of CF₄ and O₂ gas with a flow rate of 10/500 sccm at a pressure of 28 Pa, a power of 700 W, a duration of 30 seconds, and a temperature of 35° C.

FIG. 6 shows that the recess portions of the pattern were thinned by dry etching.

Furthermore, FIG. 7 shows that a shorter treatment time allows the surface of the pattern to be smoothed. The surface roughness of the initial shape in FIG. 5 was Rms=1.00 nm and Ra=0.716 nm. The surface roughness of the post-treatment shape in FIG. 7 was Rms=0.794 nm and Ra=0.662 nm. Moreover, FIG. 8 shows that each protrusion pattern having a rectangular cross section was dry-etched at a shoulder portion and thus had a triangular cross section. Thinner track grooves are expected to be formed by using the resin stamper with the triangular cross section for the mask transfer of patterning for the discrete magnetic recording medium.

Carrying out the dry etching (RIE) process on the resin stamper as described above enables the track grooves in the discrete magnetic recording medium to be smoothed (reduced roughness) and thinned.

Then, recording and reproduction experiments were carried out on the DTR magnetic recording medium produced according to the present invention.

First, the width of each groove formed in the DTR medium was set to about 25 nm. In this case, the track pitch was set to 83 nm. At this time, a land width sufficient to produce a magnetic recording mark failed to be achieved. This prevented evaluation using the drive from being performed.

An attempt was made to smooth the grooves using the method according to the present invention (short-time treatment with Ar). Then, LER (Line Edge Roughness) was successfully reduced from 7 nm to 5 nm at 3σ. The large width of the grooves themselves inhibited a sufficient land width from being obtained, thus preventing recording and reproduction from being achieved. However, it has been found that when the future improvement of master recording apparatuses allows the grooves to be thinned (improvement of S), a high SN ratio can be obtained in the future by reducing LER and thus possible noise (reduction of N).

Moreover, the method according to the present invention was used to reduce the groove width to 15 nm. Then, a land width sufficient to record signals with a sufficient SN ratio was successfully obtained (pitch itself was the same as the initial one, 83 nm). For both a medium subjected to Ar long-time treatment and a medium subjected to CF₄ treatment, error rate was 1×10^{-4.5}, corresponding to a practical level.

Appropriately thinning and smoothing the track grooves in the discrete track magnetic recording medium allows more excellent recording and reproducing characteristics to be obtained. This is because the land portions in which signals are recorded are desirably wide enough to ensure the proper SN ratio of the signals, in other words, the track grooves are desirably as thin as possible. The edge roughness of the track grooves serves as a source of noise. Thus, the track grooves are desirably smoother so as to improve signal quality.

According to the present invention, the track grooves (which correspond to the protruding portions on the resin stamper) can be thinned and smoothed by carrying out the dry etching (RIE) process on the resin stamper used for the mask transfer to the magnetic recording medium. Specifically, Ar gas alone or a mixed gas of CF₄ and O₂ enables the surface roughness to be improved with a short-time treatment or allows the tracks to be thinned with a long-time treatment.

Furthermore, the resin stamper with the pattern thus thinned and smoothed serves to provide a discrete track magnetic recording medium with thinner track grooves which offers high signal quality and which allows the track pitch to be reduced to increase the density.

The method according to the present invention can be inexpensively implemented by dry-etching the resin stamper. This eliminates the need for an expensive master recording apparatus such as an electron beam gun with a high acceleration voltage as conventionally used to thin the tracks. Furthermore, electron beams need not be extremely precisely focused during master recording, thus ensuring a sufficient beam current. This also prevents the master recording from requiring a long time because of insufficient dose. Thus, the method according to the present invention also offers high productivity.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for manufacturing a resin stamper configured to transfer a recess and protrusion pattern to an ultraviolet setting resin used as a mask in forming discrete tracks comprising the recess and protrusion pattern, on a surface of a magnetic recording layer, the method comprising:
injection-molding a resin stamper comprising a recess and protrusion pattern for the discrete tracks; and
dry-etching the recess and protrusion pattern surface of the resin stamper.

2. The method for manufacturing the resin stamper of claim 1, wherein the dry-etching is configured to narrow a protrusion pattern of the recess and protrusion pattern surface in order to widen a recess pattern.

3. The method for manufacturing the resin stamper of claim 1, wherein the protrusion pattern comprises a triangular vertical cross section.

4. The method for manufacturing the resin stamper of claim 1, wherein the dry-etching is configured to reduce roughness of the recess and protrusion pattern surface and to smooth the recess and protrusion pattern surface, while maintaining the recess and protrusion of the recess and protrusion pattern surface of the resin stamper.

5. The method for manufacturing the resin stamper of claim 1, wherein Argon (Ar) gas or a mixed gas of Tetrafluoromethane (CF₄) and Oxygen (O₂) is configured to be used in the dry-etching.

6. A method for manufacturing a magnetic recording medium, the method comprising:
injection-molding a resin stamper comprising a recess and protrusion pattern surface corresponding to a recess and protrusion pattern on the surface of the magnetic recording layer as discrete tracks;
dry-etching the recess and protrusion pattern surface of the resin stamper;
attaching the surface of the magnetic recording layer in the magnetic recording medium to the dry-etched recess and protrusion pattern surface of the resin stamper via an uncured ultraviolet setting resin layer;
irradiating the uncured ultraviolet setting resin layer with an ultraviolet ray in order to cure the ultraviolet setting resin layer;
peeling the resin stamper in order to form the ultraviolet setting resin layer comprising the recess and protrusion pattern transferred, on a surface of the magnetic recording medium; and
dry-etching through the ultraviolet setting resin layer as a mask in order to form a recess and protrusion pattern on the surface of the magnetic recording layer.

7. The method for manufacturing the magnetic recording medium of claim 5, wherein the dry-etching is configured to narrow a protrusion pattern of the recess and protrusion pattern surface of the magnetic recording medium in order to widen a recess pattern, and the resin stamper with a wide recess portion is configured to transfer a recess and protrusion pattern with a wide protruding portion to a surface of the magnetic recording medium, thus forming the recess and protrusion pattern with the wide protruding portion on the surface of the magnetic recording layer.

8. The method for manufacturing the magnetic recording medium of claim 7, wherein the protrusion pattern comprises a triangular vertical cross section.

9. The method for manufacturing the magnetic recording medium of claim 6, wherein the dry-etching is configured to reduce roughness of the recess and protrusion pattern surface and to smooth the recess and protrusion pattern surface, while maintaining the recess and protrusion of the recess and protrusion pattern surface of the magnetic recording medium.

10. The method for manufacturing the magnetic recording medium of claim 6, wherein Ar gas or a mixed gas of CF₄ and O₂ is configured to be used in the dry-etching.
